(19) United States
(12) Patent Application Publication
(10) Pub. No.: US 2009/0279408 A1
(43) Pub. Date: Nov. 12, 2009

(54) OPTICAL DATA RECORDING/REPRODUCING SYSTEM PICKING UP MULTIPLE TRACKS BETWEEN GUARD BANDS

(75) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,498

(22) PCT Filed: May 15, 2006
(86) PCT No.: PCT/IB06/51509

§ 371 Date: Nov. 26, 2007

(30) Foreign Application Priority Data
May 31, 2005 (EP) 05104676.1

(51) Int. Cl. G11B 7/135

(52) U.S. Cl. 369/112.01; G9B/7

(57) ABSTRACT

The present invention relates to an optical system for performing radial tracking on an optical record carrier (100). The optical system contains light dividing means, e.g. a grating, for separating a light beam into a main beam (52) for reading and/or recording information as readable effects on the carrier, and a plurality of auxiliary beams (52a, 52b) applicable for radial tracking. The carrier contains readable effects arranged in multiple tracks in one or more spiral (s), where the one or more spiral (s) are separated by one or more guard band(s) (5, 15) in that two guard bands enclose multiple tracks. The optical system is adapted to perform radial tracking from the reflected light of a first auxiliary beam (52a) being positioned in a first guard band (5, 15), and the optical system is further adapted to select the second auxiliary beam (52b) in order to change the track position of the main beam (52) by performing radial tracking from the reflected light of the second auxiliary beam (52b) being positioned in a second guard band.

The present invention relates to an optical system for reproducing and/or recording optically readable effects on an associated optical record carrier and performing radial tracking on the optical record carrier. The invention further relates to a method for reproducing and/or recording optically readable effects on an associated optical record carrier.

In order to meet the demand of increasing information storage capacity the available optical media, i.e. compact disc (CD), digital versatile disc (DVD) and the Blu-ray Disc (BD), show a constant improvement in storage capacity. In these optical media, the reproduction resolution has hitherto been mostly dominated by the wavelength, λ, of the reproduction light and the numerical aperture (NA) of the optical reproduction apparatus. However, since it is not easy to shorten the wavelength of the reproduction light or to increase the numerical aperture of the corresponding lens system, attempts to increase the recording density has pre-dominantly been focused at improving the recording media and/or the recording/reproduction method.

In particular, for optical media adapted for recording information two different approaches have been suggested: The land-groove format wherein information is recorded both in the groove of the track and next to the groove, and the groove-only format wherein the information is only recorded in the groove, e.g. the BD disc format. Both of these formats have advantages and disadvantages, in particular with respect to radial tracking and inter-track/symbol cross-write/erase issues.

Presently, the density limit reached by combining a track pitch of 240 nm with a channel bit length of 50 nm has shown that the capacity of the BD-type disc can potentially be increased from the current 23-25-27 GB up to 50 GB per layer of information on the media.

However, an inherent conflict between further downscaling of the track pitch versus the need for stabile radial tracking and limited cross-write/erase problems is encountered in present state of the art discs. In particular, an optical storage method with both the advantages of the land-groove format with respect to stable radial tracking and the advantages of the groove-only format with respect to limited cross-write/erase problems is therefore desirable.

Recently, the advent of Two Dimensional Optical Storage (TwoDOS) has been demonstrated, see e.g. Alexander van der Lee et al. in Japanese Journal of Applied Physics, vol. 43, No 7B, p. 4912-4914. In TwoDOS, information is written as a number of data rows in parallel along a broad spiral on a carrier, and the data is read-out in parallel from the spiral using an array of laser spots. However, for write-once and rewriteable media this is not convenient because each laser spot has to be independently controlled which thus requires multiple lasers or laser cavities. This will complicate and increase cost of the corresponding optical devices. Similarly, the heat dissipation of such optical devices increases proportional to the number of lasers or laser cavities.

Hence, an improved optical storage method would be advantageous, and in particular a more efficient and/or reliable optical system for reproducing and/or recording optically readable effects on an associated optical record carrier would be advantageous.

Accordingly, the invention preferably seeks to mitigate, alleviate or eliminate one or more of the above mentioned disadvantages singly or in any combination. In particular, it may be seen as an object of the present invention to provide an optical system that solves the above mentioned problems of the prior art with both reliable reproducing and/or recording optically readable effects on an optical record carrier and increased storage density on the optical record carrier.

This object and several other objects are obtained in a first aspect of the invention by providing an optical system for reproducing and/or recording optically readable effects on an associated optical record carrier, the system comprising:

holding means to fixate and rotate the optical record carrier,

a light source capable of emitting a light beam,

light dividing means for separating the light beam into

a main beam for reading information as readable effects in the carrier and/or recording information as readable effects on the carrier, and

a plurality of auxiliary beams applicable for radial tracking, said plurality of auxiliary beams comprising a first and a second auxiliary beam,

photodetection means capable of detecting reflected light from the optical record carrier,

the associated optical record carrier comprising, or being adapted for recording, readable effects arranged in tracks in one or more spiral(s), said one or more spiral(s) being separated by one or more guard band(s),

wherein the optical system is adapted to perform radial tracking from the reflected light of the first auxiliary beam, the first auxiliary beam being positioned in a first guard band, and

wherein the optical system is further adapted to select the second auxiliary beam to change the track position of the main beam by performing radial tracking from the reflected light of the second auxiliary beam, the second auxiliary beam being positioned in a second guard band.

The invention according to the first aspect is particularly but not exclusively advantageous for facilitating an optical system capable of recording/reproducing information on a carrier with a low track pitch, i.e. track width. The possibility of a lowered track pitch does not jeopardize the radial tracking as the radial tracking is to be performed in the guard bands. The commonly used single optical storage system with a single spiral carrier format has an inherent conflict between the radial tracking provided by the groove and the wish to minimize the track pitch, a conflict that is solved by the present optical system.

Additionally, the present invention has the advantage that even though a plurality of auxiliary spots are directed onto the carrier only a limited amount of the auxiliary spots, typically one or two auxiliary spots, and their respective reflected light beams are necessary for detection and generation of radial tracking control signals. This is different from known multi-spot tracking methods in the field that requires rather intensive means for photodection and subsequent analysis of all of the reflected light beams, see e.g. EP 0 423 364 A1. Advantageously, the present invention therefore may limit and/or simplify the necessary electronic circuitry for analysis of the reflected light from the auxiliary beams.

The present invention may provide track changing of the main beam within a spiral by selecting the appropriate auxiliary beam for radial tracking, i.e. the changing of the track position from say track number one to track number two is effected by changing the auxiliary beam used for performing radial tracking from a first to a second auxiliary beam.

It should be noted that the present invention may be applied in combination with an indication of the direction that the radial displacement should be initiated. Otherwise a switch between e.g. two auxiliary spots may create a radial displacement in a wrong direction i.e. away from the intended radial position and/or track of the main beam.

In a particular embodiment, the first auxiliary beam may be positioned in e.g. the first neighbouring guard band of the spiral wherein the main beam is presently positioned, and for changing the track position of the main beam within the spiral, the second auxiliary beam is applied for radial tracking and will be end up being positioned in the second guard band. Frequently, the first and second guard band may be the one and the same guard band, but when the main beam is positioned around a central position within a spiral a guard band change procedure may additionally take place. This will be further illustrated below in the detailed description of the invention.

The first and second guard band may typically be the nearest guard band to the spiral where the main beam is positioned, but a more remotely positioned guard band may be applicable for radial tracking according to the present invention as well, if sufficiently intensity of the reflected light of the one or more auxiliary beam(s) in question is detectable.

It is a particular advantage of the present invention that it is possible to switch off the one or more photo detectors associated with detection of reflected light from auxiliary beams that are not applied in radial tracking, preferably also electronic circuits e.g. amplification and/or pre-processing may be turned off. This provides the present invention of the advantage of reduced power consumption during operation and will additionally lower the system cost as the powering and/or cooling may be reduced.

Within the context of the present invention the main beam may under certain conditions be considered to be an auxiliary beam, because the main beam may also be used for radial tracking in a guard band during some track changing procedures as will be further elaborated below.

Particularly, the photodetection means may comprise at least one photodetector corresponding to each auxiliary beam. Advantageously, the optical system may comprise switching means for selecting the at least one photodetector that corresponds to the first or the second auxiliary beam for application in radial tracking. The switching means may be transistors or similarly components. Alternatively, miniature electro-mechanical systems (MEMS) may be applied.

Advantageously, the plurality of auxiliary beams may be adapted to be disposed substantially symmetrical relative to the main beam on the associated optical record carrier. Additionally, the plurality of auxiliary beams may be adapted to be substantially equidistantly positioned on the associated optical record carrier. Thus, on both sides of the main beam, the auxiliary beams are separated by a fixed distance. Alternatively, the main beam may additionally be considered to be an auxiliary beam. This may be achieved by a grating as light dividing means. A grating may however also provides asymmetrical diffraction. Recently, gratings with substantially equal intensity in diffracted spots have appeared. Such gratings may beneficially be applied within the context of the present invention.

Beneficially, the separation distance in the radial direction between the plurality of auxiliary beams may be substantially equal to an integer times the track pitch of the associated optical record carrier in order to fit for easy radial tracking with the carrier.

Typically, the number of auxiliary beams may be at least equal to the number of tracks in the one or more spiral(s).

In a first embodiment, each auxiliary beam may have at least two corresponding photodetectors, and wherein the optical system may correspondingly be adapted to perform radial tracking by the well known push-pull (PP) method.

In a second embodiment, each auxiliary beam may have at least four corresponding photodetectors, and wherein the optical system may be adapted to perform radial tracking by the differential phase detection (DPD) method. However, the guard band should contain data to obtain DPD signal in this case.

Beneficially, radial tracking is performed from a single auxiliary beam positioned in a guard band as e.g. with the PP and PDP method.

In a particular embodiment, the optical system may adapted to perform radial tracking from the reflected light of the first auxiliary beam and an additional third auxiliary beam, the first and the third auxiliary beam being positioned in a first and a third guard band, respectively, and wherein the optical system may be adapted to select the second auxiliary beam and an additional fourth auxiliary beam in order to change the track position of the main beam by performing radial tracking from the reflected light of the second and the fourth auxiliary beam, the second and the fourth auxiliary beam being positioned in a second and fourth guard band, respectively. Thus, in this embodiment pairs of spots are applied for radial tracking. This is particular suited for performing radial tracking by the differential central aperture (DCA) method.

In another embodiment, the associated optical record carrier comprises a plurality of spirals arranged in concentric consecutive layers on the optical record carrier with one spiral in each layer, said layers being separated by guard bands, the plurality of spirals having a starting point for each track and an end point for each track, and wherein each end point of a track is positioned with a relative angular separation in relation to the start point of the adjacent consecutive spiral, and wherein the optical system, upon changing reading and/or recording of readable effects from a first spiral to a second spiral, is adapted to temporally position the main beam substantially in the guard band between the first spiral and second spiral. This is particularly advantageous in order to reduce settling time of the optical system before reading/writing in the second spiral. Moreover it is an advantage if the position of the main beam in guard band may be substantially equal to the radial position of the start point of the track of the second spiral, the radial position being measured from a substantially central position on the optical record carrier, to even further reduce settling time.

In a second aspect, the present invention relates to a method for operating an optical system adapted for reproducing and/or recording optically readable effects on an associated optical record carrier, the method comprising the steps of:

providing holding means to fixate and rotate the optical record carrier,

providing a light source capable of emitting a light beam,

providing light dividing means for separating the light beam into

a main beam for reading information as readable effects in the carrier and/or recording information as readable effects on the carrier,

a plurality of auxiliary beams applicable for radial tracking, said plurality of auxiliary beams comprising a first and a second auxiliary beam,

providing photodetection means capable of detecting reflected light from the optical record carrier,

the associated optical record carrier comprising, or being adapted for recording, readable effects arranged in tracks in one or more spiral(s), said one or more spiral(s) being separated by one or more guard band(s),

the method further comprising the steps of:

performing radial tracking from the reflected light of the first auxiliary beam, the first auxiliary beam being positioned in a first guard band, and

selecting the second auxiliary beam in order to perform radial tracking from the reflected light of the second auxiliary beam, the second auxiliary beam being positioned in a second guard band, to change the track position of the main beam.

In a third aspect, the invention relates to a computer program product being adapted to enable a computer system comprising at least one computer having data storage means associated therewith to control an optical system according to the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical system may be changed to operate according to the present invention by installing a computer program product on a computer system controlling the said optical system. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

The present invention will now be explained with reference to the accompanying Figures, where

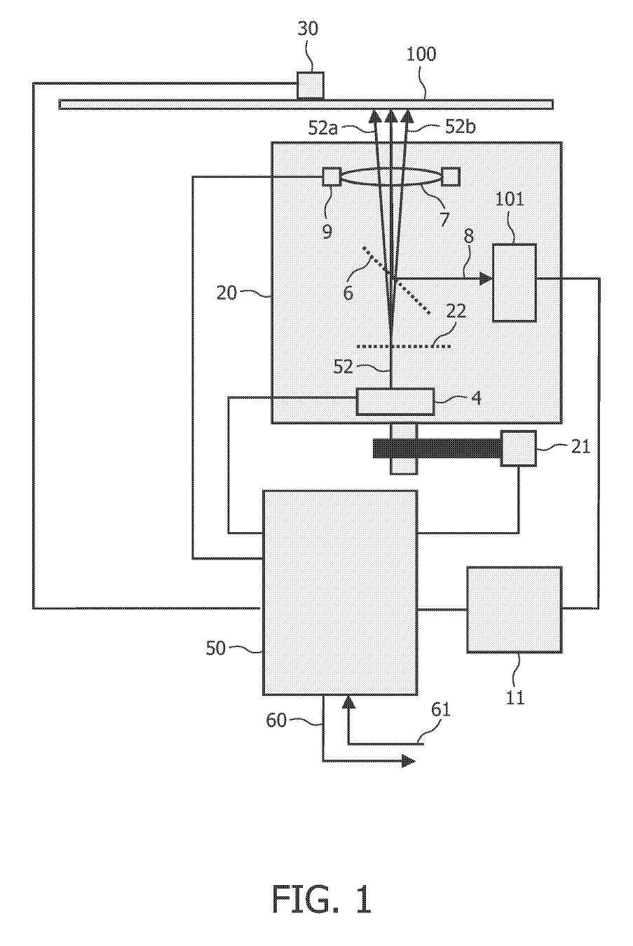

FIG. 1 is a schematic drawing of the optical system according to the first aspect of the invention,

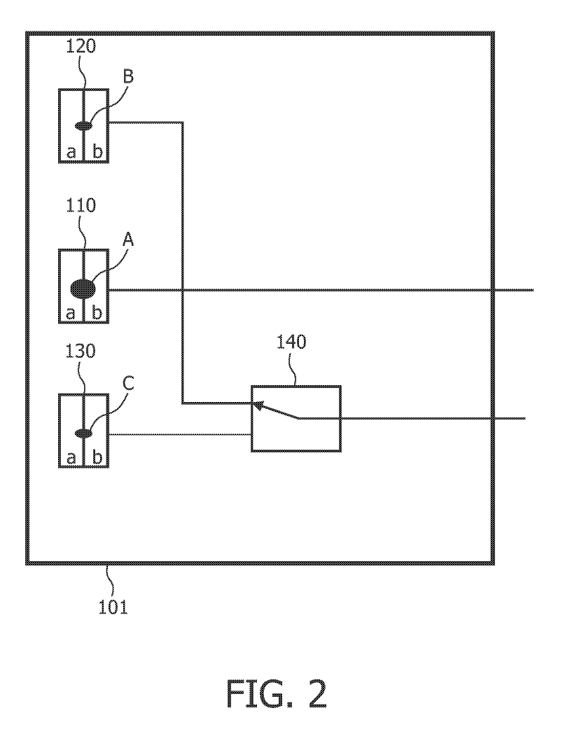

FIG. 2 is a schematic drawing of photodetection means according to the first aspect of the invention,

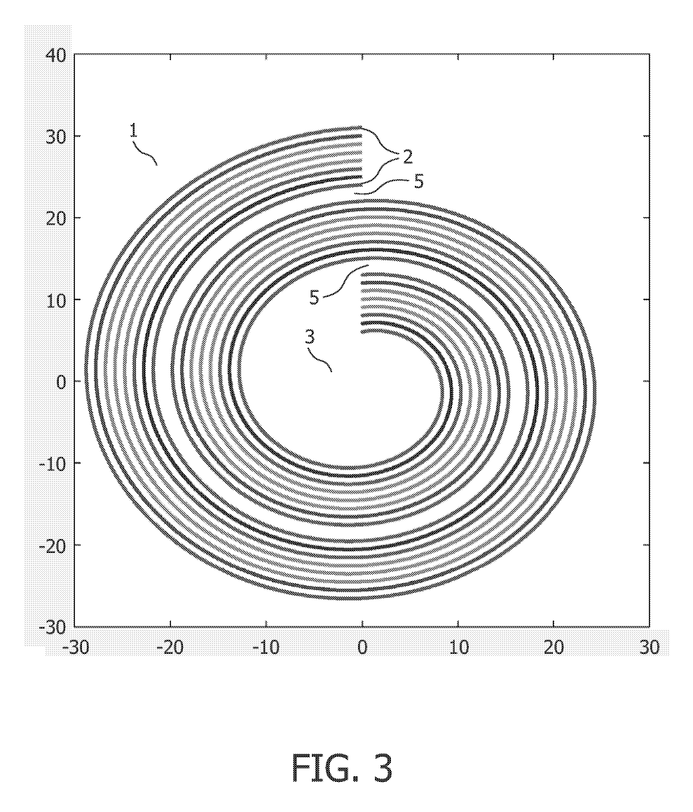

FIG. 3 is a schematic drawing of a carrier format particular suited for operation with the optical system according to the first aspect of the invention,

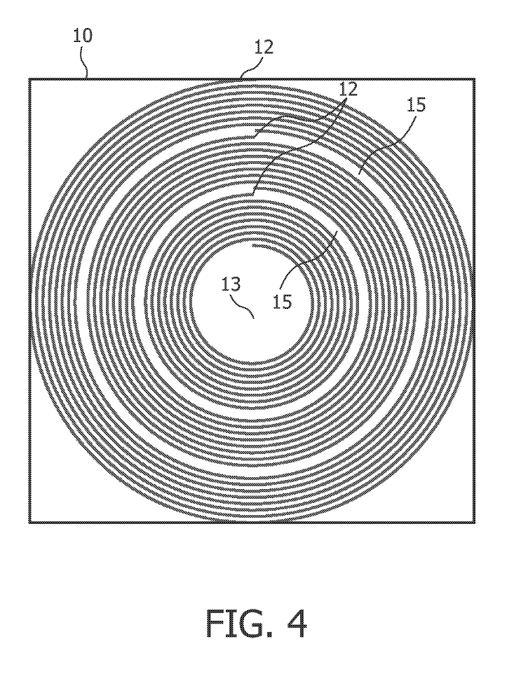

FIG. 4 is a schematic drawing of another carrier format particular suited for operation with the optical system according to the first aspect of the invention,

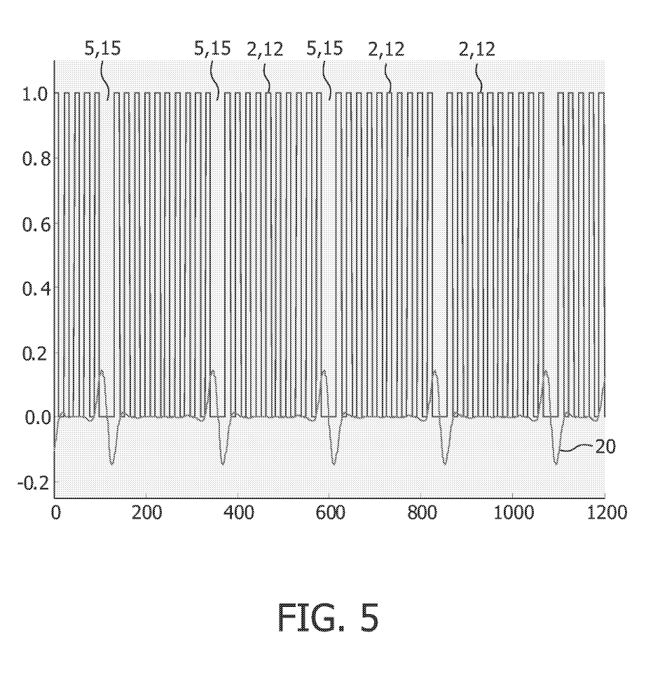

FIG. 5 is shows a vertical-radial cross-section of a carrier superimposed with a corresponding radial tracking error signal,

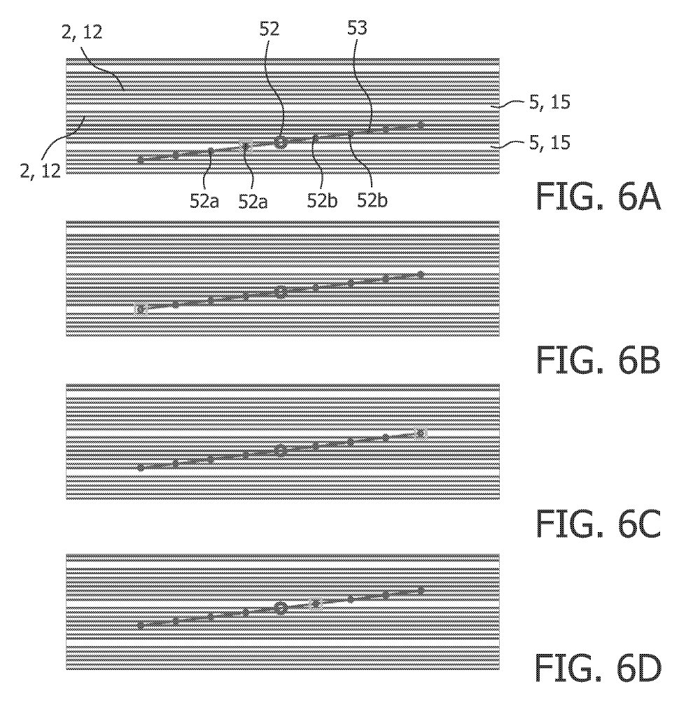

FIG. 6 is a series of drawings illustrating the main beam directed at various track positions within a spiral and the corresponding different auxiliary beams,

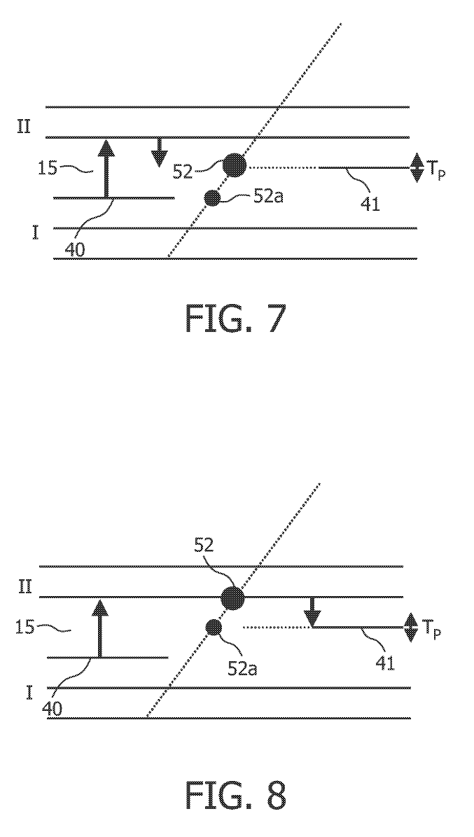

FIG. 7 schematically shows an embodiment for a main beam track changing procedure between spirals of a format of FIG. 4 with so-called shifted edges,

FIG. 8 schematically shows a disadvantage if the embodiment of FIG. 7 is not applied, and

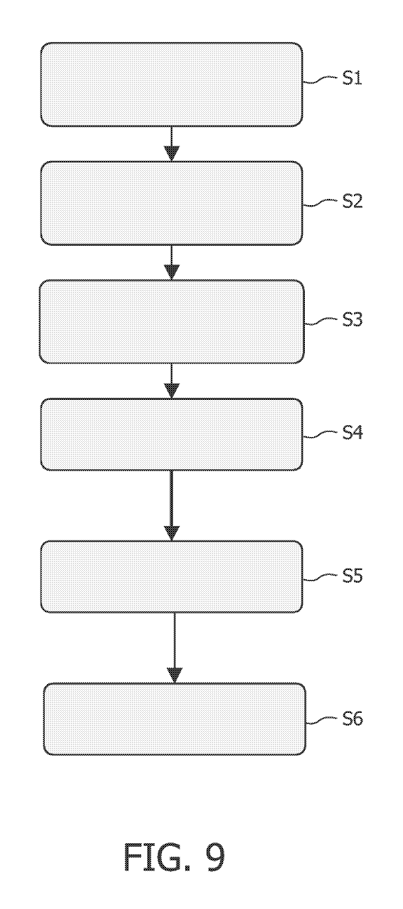

FIG. 9 is a flow chart illustrating the method according to the second aspect of the invention.

FIG. 1 schematically shows an optical system and associated optical carrier 100 according to the invention. The carrier 100 is fixed and rotated by holding means 30.

The carrier 100 comprises a material suitable for recording information by means of a radiation beam 52. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 100.

The apparatus comprises an optical head 20, sometimes called an optical pick-up (OPU), the optical head 20 being displaceable by actuation means 21, e.g. an electric stepping motor. The optical head 20 comprises a photo detection system 101, a radiation source 4, a beam splitter 6, an objective lens 7, and lens displacement means 9. The optical head 20 also comprises light dividing means 22, such as a grating or a holographic pattern that is capable of splitting the radiation beam 52 into at least three components 52, 52a and 52b where 52a and 52b may denote the first order diffraction on each side of the main beam 52. For reason of the clarity the radiation beam 52, 52a, 52b is shown as triplet single beam after passing through the beam splitting means 22 but more auxiliary spots are typically present if e.g. the light dividing means 22 is a grating. Similarly, the radiation 8 reflected also comprises more than one component, e.g. the reflections of the three spots 52, 52a, and 52b, and diffractions thereof, but only one beam 8 is shown in FIG. 1 for clarity.

It is contemplated that, in an alternative embodiment of the present invention, the light source 4 capable of emitting a light beam 52 and the light dividing means 22 for separating the light beam into a main beam 52 and a plurality of auxiliary beams 52a and 52b may be substituted by a plurality of light sources. One of said light sources may provide the main beam and the other light sources may provide the auxiliary beams. Possibly a combination of a plurality of light sources and one or more light dividing means, e.g. gratings, may be applied along the principles of the present invention. In the context of the present invention, a light source is understood to include any kind of radiation source capable of emitting radiation suitable for optical storage of information, such as infrared light (IR), visible light, ultra violet light (UV), X-rays etc.

The function of the photo detection system 101 is to convert radiation 8 reflected from the carrier 100 into electrical signals. Thus, the photo detection system 101 comprises several photo detectors, e.g. photodiodes, charged-coupled devices (CCD), etc., capable of generating one or more electric output signals that are transmitted to a pre-processor 11. The photo detectors are arranged spatially to one another, and with a sufficient time resolution so as to enable detection of focus (FE) and radial tracking (RTE) errors in the pre-processor 11. Thus, the pre-processor 11 transmits focus (FE) and radial tracking error (RTE) signals to the processor 50. The photo detection system 101 can also transmit a read signal or RF signal representing the information being read from the carrier 100 to the processor 50 through the pre-processor 11. The read signal may possibly converted to a central aperture (CA) signal by a low-pass filtering of the RF signal in the processor 50.

The radiation source 4 for emitting a radiation beam 52 can for example be a semiconductor laser with a variable power, possibly also with variable wavelength of radiation. Alternatively, the radiation source 4 may comprise more than one laser.

The optical head 20 is optically arranged so that the radiation beam 52 is directed to the optical carrier 100 via a beam splitter 6, and an objective lens 7. Additionally, a collimator lens (not shown) may be present before the objective lens 7. Radiation 8 reflected from the carrier 100 is collected by the objective lens 7 and, after passing through the beam splitter 6, falls on a photo detection system 101 which converts the incident radiation 8 to electric output signals as described above.

The processor 50 receives and analyses output signals from the pre-processor 11. The processor 50 can also output control signals to the actuation means 21, the radiation source 4, the lens displacement means 9, the pre-processor 11, and the holding means 30, as illustrated in FIG. 1. Similarly, the processor 50 can receive data, indicated at 61, and the processor 50 may output data from the reading process as indicated at 60.

FIG. 2 is a schematic drawing of photodetection means 101 according to the first aspect of the invention. Three photo detector sections 110, 120, 130 are shown. On each of the photo detector sections 110, 120, 130, a corresponding spot, A, B, and C, respectively are shown. As indicated by the relative size of the spots A, B, and C, the spot A indicates the reflected light originating from the main spot whereas the spots B and C indicates reflected light from two auxiliary spots. In the embodiment shown in FIG. 2 the photo detector sections 110, 120, 130 are divided into two photo detectors a and b. This is the normal optical configuration for performing tracking by the push-pull (PP) method, where a relative weighting between the two detectors a and b is applied for generating a radial error signal denoting the error or deviation from an intended radial position and the actual position. Application of the present invention enables a switch or selector 140 that is adapted for selecting the appropriate auxiliary spot, in FIG. 2 spot B, for radial tracking by transmitting further the corresponding signal from photo detector section 120 to the pre-processor 11 and processor 50. The switch 140 is preferably an electronic switch, e.g. employing suitable transistor circuits, MEMS components etc.

However, the photo detector sections 110, 120, 130 may also apply the differential phase detection (DPD) method where the sections consist of four photo detectors. Note, that this embodiment requires that data is provided in the guard band(s). Similarly, the photo detector sections 110, 120, 130 can consist of a single photo detector for radial tracking by applying the low-pass filtered signal from a pair of auxiliary spots. In the latter case, the present invention may implemented by selecting a pair of first auxiliary spots, and selecting another second pair of auxiliary spots for radial tracking according to the present invention.

In FIGS. 3 and 4, two particular formats of an optical carrier format that are well suited for being applied by an optical system according to the present invention are illustrated. However, it should be stressed that the principle of the present invention is not limited to these two formats. In particular the present invention may equally be applied in context with the so-called TwoDOS format by applying several main beams for parallel reading/writing and broad-track changing, i.e. changing from one radial position to another of the single broad-track spiral, may be performed according to the present invention.

FIG. 3 is a schematic drawing of a carrier format particular suited for operation with the optical system according to the first aspect of the invention. A plurality of tracks 2 are disposed substantially spirally and substantially concentrically with respect to central position 3 on the carrier. Each track 2 is adapted for recording and/or reproducing optically readable effects positioned substantially in a groove (not shown).

The plurality of tracks 2 are arranged adjacently in a multi-track spiral 1 on the optical record carrier and the number of tracks in FIG. 3 is eight. The number of tracks 2 in the broad spiral 1 is determined by a compromise between the radial servo system complexity and the storage capacity decrease due to the fact that the guard band 5 contains no data or possibly that the data density in the guard band 5 is lower than in the grooves of the broad spiral. It is expected that the multi-spiral 1 with eight tracks is the most practical one; although the broad spirals 1 with somewhat smaller or somewhat larger number tracks are also feasible. Thus, the number of tracks 2 may also be: 2, 3, 4, 5, 6, 7, 8, 9, 10, 11, 12, 13, 14, 15, 16, 17, 18, 19, and 20. The tracking area 5 between the windings of the multi-track spiral 1 is adapted for providing a radial tracking error signal from the optical carrier 100.

FIG. 4 is a schematic drawing of another carrier format particular suited for operation with an optical system according to the first aspect of the invention. A plurality of tracks 12 are disposed substantially spirally and substantially concentrically with respect to a central position 13 on the carrier. Each track 12 is adapted for recording and/or reproducing optically readable effects positioned substantially in a groove (not shown). The plurality of spirals 10 are arranged in concentric consecutive layers 12 on the optical record carrier with one spiral in each layer similar to the structure of an onion. In FIG. 4, just three consecutive spirals 12 are shown for clarity but for an actual carrier the number of spirals 12 or “onion-shelves” may vary between 2 and 1,000,000. The tracking areas 15 between the spirals 12 are adapted for providing a radial tracking error signal from the optical record carrier as will be further explained in FIG. 5.

FIG. 5 shows a vertical-radial cross-section of a carrier 100 superimposed with the corresponding radial tracking error signal 20 obtained by the one spot push-pull radial tracking error method. The scales of the plot are arbitrary. FIG. 5 illustrates how a tracking signal is obtained from a carrier 100 by an optical system according to the first aspect of the present invention. In FIG. 5, the radial position on the carrier 100 is plotted on the horizontal scale. On the vertical scale, the push-pull radial tracking signal 20 from the reflected light 8 of auxiliary spot 52a or 52b is plotted which corresponds to the auxiliary spot being scanned along the radial direction. The physical structure of the grooves is also indicated on the vertical scale. The amplitude of 1 corresponds to bottom of the grooves, whereas the carrier surface is positioned at an amplitude of 0. Thus, as seen there are no grooves in the tracking area(s) 5 and 15.

The grooves are grouped in either a multi-spiral 1 with tracks 2 or consecutive spirals 12 in the carrier format 10. Both are 10-track-wide, and the inter-spiral separation, i.e. the tracking area(s) or guard band 5 or 15. This may be achieved by not mastering every 11-th groove for the format shown in FIG. 4. Since the optical spot resolution is finite leading essentially to a low-pass characteristic of the channel response, the very high frequency of tracks within the broad groups 2 or 12 is not getting captured. In the given embodiment the following data applies: numerical aperture (NA)=0.85, wave length of light=405 nm and track pitch of 220 nm with a duty circle of 50%.

As it is visible in FIG. 5, there is an almost-zero push-pull signal 20 not suitable for tracking within the tracks 2 of the multi-spiral 1 or within the consecutive spirals 12. At the guard bands, however, the groove structure has a significant lower frequency component due to the larger track spacing there, and the push-pull tracking signal 20 from the auxiliary spot 52a or 52b is strong and provides a clear “S-curve” around the middle of the guard band 5 and 15. This means that the auxiliary spot 52a or 52b can reliably track the middle of the guard band 5 and 15 from the obtained radial tracking signal but the individual tracks 2 of multi-spiral 1 or the consecutive spirals 12 does not give rise to a useful radial tracking error signal. In the given example, the guard band width is 3×120 nm=360 nm, while the push-pull signal 20 vanishes only at the spatial track spacing below 2×120 nm=240 nm for the given characteristics of the optical spot. That means that the guard band 5 and 15 can also be made narrower, down to approximately 280 nm/2=140 nm.

FIG. 6 is a series of drawings illustrating the main beam 52 directed at various track positions within a spiral and the corresponding different auxiliary beams 52a and 52b. For illustrative purposes only a small cut-out section of the tracks 2 and 12 are shown. In FIG. 6, the main beam 52 is encircled by a ring to distinguish the main beam 52 from the auxiliary beams 52a and 52b. In the embodiment shown in FIG. 6, the auxiliary beams 52a and 52b are positioned symmetrical relative to the main beam 52 and equidistantly on the illustrative line marked 53. This may be obtained by using a grating for light dividing means 22. The auxiliary spot e.g. 52a in part A that is selected for radial tracking is indicated with a square surrounding the spot 52a. In the embodiment of FIG. 6, the radial inter-distance (vertical in FIG. 6) of the main spot 52 and the auxiliary 52a and 52b are substantially equal to the track pitch of the tracks 2 and 12 to facilitate easy changing of track position for the main beam 52 during radial tracking. Additionally, the guard band width is substantially equal to the track pitch (Tₚ) for the 100% duty cycle. However, if a 50% duty cycle is applied the guard band width should be 1.5 times the track pitch (Tₚ). Such symmetric configurations where the optical system and the carrier format 1 and 10 are fitted together with respect to guard bands, track pitch (Tₚ) and radial separation of the spots 52, 52a and 52b provides a particular advantage in connection with the present invention.

In FIG. 6 part A, the main beam 52 is positioned in the first track counted from below in the spiral. The nearest auxiliary beam 52a is positioned in the guard band 5 and 15 and used for radial tracking as described above. While light is reflected from the other auxiliary spots 52a and 52b not positioned in the guard band 5 and 15, the reflected light from these auxiliary spot 52a and 52b need not to be detected for radial tracking purposes.

In FIG. 6 part B, the main beam 52 is positioned in the fourth track counted from below in the spiral. Now, the fourth auxiliary beam (counted from the main beam 52) is positioned in the guard band 2 and 12. For the optical system of this embodiment this is outermost auxiliary spot 52a. Therefore the auxiliary spots 52a used for radial tracking in the guard band 5 and 15 can not be applied for radial tracking of the fifth track counted from below in the spiral.

In FIG. 6 part C, there is consequently made a change in the guard band 5 and 15 used by the tracking auxiliary spot 52b as a result of the main beam 52 changing position from the fourth track (as shown in FIG. 6 part B) to the fifth track. As seen in FIG. 6 part C there is a change from the lower guard band to the upper guard band relative to spiral where the main beam 52 is positioned.

In FIG. 6 part D, the situation where the main beam 52 is reading/writing in the eighth track counted from below in the spiral is shown. Similarly, to the situation shown in FIG. 6 part A the auxiliary beam 52b being the nearest neighbor to the main beam 52 is being used for radial tracking in the guard band 5 and 15. As it is clear from FIG. 6 the number of auxiliary beams 52a and 52b should be at least equal to the number of tracks 5 and 15.

FIG. 7 schematically shows an embodiment for a main beam track changing procedure between spirals of a format of FIG. 4 with so-called shifted edges. In particular the optical system may be operated in constant linear velocity (CLV) mode. This embodiment is particular advantageous for a carrier 100 operated in a constant linear velocity (CLV) mode. The end point 40 for a spiral I is positioned with a tangential linear separation in relation to the start point 41 of the adjacent consecutive spiral II as shown in FIG. 7. The tangential linear separation between adjacently positioned spirals I and II is substantially constant on the optical record carrier 100. The optical system is adapted, upon changing from a first spiral I to a second spiral II, to temporally position the main beam 52 substantially in the guard band 15 between the first spiral I and second spiral II. This may be done in two steps: An initial change indicated with the bold arrow from spiral I to spiral II followed by a smaller backwards displacement (smaller bold arrow) of the optical head 20 and therefore of the main beam 52. The initial change may be indicated on the end point 40 by a pre-determined data sequence.

After the smaller backwards displacement the main beam 52 is preferably positioned so that the position of the main beam 52 in the guard band 15 is substantially equal to the radial position of the start point 41 of the track of the second spiral II, the radial position being measured from a substantially central position 13 on the optical record carrier 100 as shown in FIG. 4. The alignment may be done by radial tracking in the guard band 15 before the start point 41 by the main beam 52 and/or one or more auxiliary spots 52a. Alternatively the backwards displacement may be combined with a temporally disablement of the radial tracking servo loop. Once the main beam starts reading/writing in the start point 41 radial tracking via the auxiliary spot 52a in the guard band 15 may be restarted. The above procedure is a so-called pre-jump procedure performed to reduce and/or eliminate running-in time and/or mechanical re-positioning of the optical head 20 before the main beam 52 is correctly positioned for recording/writing on the starting point 41 of the spiral II. It is expected that the above pre-jump procedure may increase the storage capacity of the carrier 100 with 1-5%.

FIG. 8 schematically shows the disadvantage if the embodiment of FIG. 7 is not applied. A normal radial tracking procedure would start with an similar initial displacement from spiral I to spiral II. However, due to the radial tracking performed via the auxiliary spot 52a in the guard band 15 the main beam will not be aligned with the starting point 41 for the track of spiral II. The main beam 52 will only be backwards displaced (the smaller bold arrow) when the auxiliary spot 52a will be repositioned as the spot 52a reach the starting point 41. In this way, storage capacity on or around the starting point 41 of the spiral II may not be fully exploited.

FIG. 9 is a flow chart illustrating the method according to the second aspect of the invention. This method relates to operating an optical system adapted for reproducing and/or recording optically readable effects on an associated optical record carrier 100, the method comprising the steps of:

S1 providing holding means to fixate and rotate the optical record carrier 100,

S2 providing a light source capable of emitting a light beam,

S3 providing light dividing means 22 for separating the light beam 52 into

a main beam 52 for reading information as readable effects in the carrier 100 and/or recording information as readable effects on the carrier,

a plurality of auxiliary beams 52a and 52b applicable for radial tracking, said plurality of auxiliary beams comprising a first and a second auxiliary beam,

S4 providing photodetection means 101 capable of detecting reflected light 8 from the optical record carrier 100,

the associated optical record carrier 100 comprising, or being adapted for recording, readable effects arranged in tracks in one or more spiral(s) 2 and 12, said one or more spiral(s) being separated by one or more guard band(s) 5 and 15,

the method further comprising the steps of:

S5 performing radial tracking from the reflected light of the first auxiliary beam 52a, the first auxiliary beam being positioned in a first guard band 5 and 15, and

S6 selecting the second auxiliary beam 52b in order to change the track position of the main beam 52 by performing radial tracking from the reflected light of the second auxiliary beam, the second auxiliary beam being positioned in a second guard band 5 and 15.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical system for reproducing and/or recording optically readable effects on an associated optical record carrier (100), the system comprising:
holding means (30) to fixate and rotate the optical record carrier,
a main light beam (52) for reading information as readable effects in the carrier and/or recording information as readable effects on the carrier, and
a plurality of auxiliary light beams (52a, 52b) applicable for radial tracking, said plurality of auxiliary beams comprising a first (52a) and a second (52b) auxiliary beam,
photodetection means (110, 120, 130) capable of detecting reflected light (8) from the optical record carrier,
the associated optical record carrier comprising, or being adapted for recording, readable effects arranged in a plurality of tracks arranged in one or more spiral(s) (2, 12), said one or more spiral(s) being separated by one or more guard band(s) (5, 15),
wherein the optical system is adapted to perform radial tracking from the reflected light of the first auxiliary beam (52a), the first auxiliary beam being positioned in a guard band (5, 15), and
wherein the optical system is further adapted to select the second auxiliary beam (52b) in order to change the track position of the main beam (52) by performing radial tracking from the reflected light of the second auxiliary beam, the second auxiliary beam being positioned in a guard band (5, 15).

2. An optical system according to claim 1, wherein said photodetection means comprises at least one photodetector (110, 120) corresponding to each auxiliary beam (52a, 52b).

3. An optical system according to claim 2, wherein the optical system comprises switching means (140) for selecting the at least one photodetector that corresponds to the first or the second auxiliary beam for application in radial tracking.

4. An optical system according to claim 1, wherein the plurality of auxiliary beams (52a, 52b) are adapted to be disposed substantially symmetrical relative to the main beam (52) on the associated optical record carrier (100).

5. An optical system according to claim 4, wherein the plurality of auxiliary beams (52a, 52b) are adapted to be substantially equidistantly positioned on the associated optical record carrier (100).

6. An optical system according to claim 5, wherein the separation distance in the radial direction between the plurality of auxiliary beams (52a, 52b) is substantially equal to an integer times the track pitch (Tₚ) of the associated optical record carrier (100).

7. An optical system according to claim 1, wherein the number of auxiliary beams (52a, 52b) is at least equal to the number of tracks in the one or more spiral(s) (2, 12).

8. An optical system according to claim 2, wherein each auxiliary beam (52a, 52b) has at least two corresponding photodetectors, and wherein the optical system is adapted to perform radial tracking by the push-pull (PP) method.

9. An optical system according to claim 2, wherein each auxiliary beam (52a, 52b) has at least four corresponding photodetectors, and wherein the optical system is adapted to perform radial tracking by the differential phase detection (DPD) method.

10. An optical system according to claim 1, wherein radial tracking is performed from a single auxiliary beam (52a, 52b) positioned in a guard band (5, 15).

11. An optical system according to claim 1, wherein the optical system is adapted to perform radial tracking from the reflected light (8) of the first auxiliary beam and an additional third auxiliary beam, the first and the third auxiliary beam being positioned in a first and a third guard band (5, 15), respectively, and wherein the optical system is adapted to select the second auxiliary beam and an additional fourth auxiliary beam in order to change the track position of the main beam (52) by performing radial tracking from the reflected light (8) of the second and the fourth auxiliary beam, the second and the fourth auxiliary beam being positioned in a second and fourth guard band (5, 15), respectively.

12. An optical system according to claim 11, wherein the optical system is adapted to perform radial tracking by the differential central aperture (DCA) method.

13. An optical system according to claim 1, wherein the associated optical record carrier comprises a plurality of spirals (12) arranged in concentric consecutive layers on the optical record carrier (100) with one spiral in each layer, said layers being separated by guard bands (5, 15), the plurality of spirals having a starting point (41) for each track and an end point (40) for each track, and wherein each end point of a track (41) is positioned with a relative angular separation in relation to the start point (40) of the adjacent consecutive spiral, and wherein the optical system, upon changing reading and/or recording of readable effects from a first spiral (I) to a second spiral (II), is adapted to temporally position the main beam (52) substantially in the guard band (5, 15) between the first spiral and second spiral.

14. An optical system according to claim 13, wherein the position of the main beam (52) in the guard band (15) is substantially equal to the radial position of the start point (41) of the track of the second spiral (II), the radial position being measured from a substantially central position (13) on the optical record carrier (100).

15. A method for operating an optical system adapted for reproducing and/or recording optically readable effects on an associated optical record carrier (100), the method comprising the steps of:
providing holding means (30) to fixate and rotate the optical record carrier,
providing a main light beam (52) for reading information as readable effects in the carrier and/or recording information as readable effects on the carrier,
providing a plurality of auxiliary light beams (52a, 52b) applicable for radial tracking, said plurality of auxiliary beams comprising a first (52a) and a second (52b) auxiliary beam,
providing photodetection means (110, 120, 130) capable of detecting reflected light (8) from the optical record carrier,
the associated optical record carrier comprising (100), or being adapted for recording, readable effects arranged in a plurality of tracks arranged in one or more spiral(s) (2, 12), said one or more spiral(s) being separated by one or more guard band(s) (5, 15),
the method further comprising the steps of:
performing radial tracking from the reflected light of the first auxiliary beam (52a), the first auxiliary beam being positioned in a guard band (5, 15), and
selecting the second auxiliary beam (52b) in order to change the track position of the main beam (52) by performing radial tracking from the reflected light of the second auxiliary beam, the second auxiliary beam being positioned in a guard band (5, 15).

16. A computer program product being adapted to enable a computer system comprising at least one computer having data storage means associated therewith to control an optical system according to claim 15.
